(19) United States
(12) Patent Application Publication
(10) Pub. No.: US 2011/0174995 A1
(43) Pub. Date: Jul. 21, 2011

(54) SINGLE PHOTON EMISSION SYSTEM

(75) Inventors: Steven Trpkovski, Altona Meadows (AU); David Allan Simpson, Melton (AU); Eric Ampem-Lassen, Mill Park (AU); Brant Cameron Gibson, Victoria (AU)

(73) Assignee: THE UNIVERSITY OF MELBOURNE, Parkville (AU)

(21) Appl. No.: 12/919,191

(22) PCT Filed: Feb. 25, 2009
(86) PCT No.: PCT/AU2009/000214

§ 371 Date: Mar. 14, 2011

(30) Foreign Application Priority Data
Feb. 25, 2008 (AU) 2008900886

(51) Int. Cl. G21K 5/00

(52) U.S. Cl. 250/493.1

(57) ABSTRACT

The present disclosure provides a method of forming a single photon emission system and a single photon emission system. The method comprises providing a single photon source arranged for single photon emission at a predetermined wavelength in response to a suitable excitation. The single photon source comprises a particle for generating the single photons. The method also comprises providing an optical pump source arranged to provide the suitable excitation in the form of suitable photons. In addition, the method comprises adjusting a pathway of the photons provided by the optical pump source and a position of the single photon source relative to each other so that the single photon source is located at a predetermined location relative to the pathway of the photons provided by the optical pump source and in use single photons are emitted by the single photon source. Providing the single photon source comprises identifying the particle for generating the single photons at a location that is remote from the predetermined location.

### FIELD OF THE INVENTION

The present invention broadly relates to a photon emission system.

### BACKGROUND OF THE INVENTION

Optical fibres provide avenues for transmission of large quantities of data at high speed. However, conventional optical data transmission systems typically only provide limited security and unauthorised access to information associated with the transmitted data may be a problem.

Quantum communication systems are optical data transmission systems that enable secure transmission of the data. Quantum communication relies on the principals of quantum mechanics and requires transmission of single photons in contrast to a large number of photons that are transmitted using conventional optical data transmission systems. If the data is transmitted in the form of pulses of single photons, it can be verified if the data has been accessed and/or changed in any way by an unauthorised party.

Current quantum communication systems rely on attenuated laser light to provide the single photons. However, such systems guarantee single photons with a reliability of only 85%. True sources of single photons are available at present only in laboratories and comprise very large and complicated set-ups. There is a need for technological advancement.

### SUMMARY OF THE INVENTION

The present invention provides in a first aspect a method of forming a single photon emission system, the method comprising:
providing a single photon source arranged for single photon emission at a predetermined wavelength in response to a suitable excitation, the single photon source comprising a particle for generating the single photons, the particle being held by a holder;
providing an optical pump source arranged to provide the suitable excitation in the form of suitable photons;
adjusting a pathway of the photons provided by the optical pump source and a position of the single photon source relative to each other so that the single photon source is located at a predetermined location relative to the pathway of the photons provided by the optical pump source and in use single photons are emitted by the single photon source;
wherein providing the single photon source comprises identifying the particle for generating the single photons at a location that is remote from the predetermined location.

The step of providing the single photon source typically comprises identifying a single photon emission property of the particle prior to holding the particle by the holder.

The method may also comprises arranging the single photon source and the optical pump source so that single photons are in use emitted in a direction away from the holder, typically without being transmitted through a portion of the holder.

The present invention provides in a second aspect a single photon emission system formed by the method in accordance with the first aspect of the present invention.

Throughout this specification the term “single photon emission” is used for emission of photons in a manner so that only one photon is emitted at a time and the term “single photon source” is used for a source of photons that is arranged for single photon emission. For example, the single photon source may emit in use a sequence or pulse of single (individual) photons.

The single photon source typically is pre-characterised at a remote location and prior to assembly of the single photon emission system. Consequently, the single photon emission system typically does not have to contain equipment for identifying a single photon emitting particle and/or characterising single photon emission properties. The single photon emission system according to embodiments of the present invention therefore has the significant advantage that the single photon emission system may be of a much more compact dimension and may be of a less complicated design than known laboratory-based single photon emission systems, which comprise equipment for identifying a particle arranged for single photon emission, typically amongst a large number of other particles, and further characterisation equipment.

The single photon emission system typically also comprises a positioner for positioning the single photon source and the optical pump source, or an optical component that determines an optical pathway of the photons emitted by the optical pump source, relative to each other so that in use the photons emitted by the optical pump source are directed to the single photons source and single photons are generated.

Further, the single photon emission system typically comprises a feedback loop arranged to control the positioner based on an output of the generated single photons. The positioner and feedback loop typically are arranged so that adjustment of a position of the single photon source relative to the optical pump source, or an optical component that determines an optical pathway of the photons emitted by the optical pump source, can be performed in an automated manner. The single photon typically is arranged so that control of the positioner is computer software supported. For example, the positioner may be arranged so that a beam of the photons that are in use emitted by the optical pump source is scanned over a surface of the single photon source. The single photon emission system typically also comprises a single photon detector for providing information concerning the single photon emission output. The positioner and feedback loop typically are arranged to identify a position of the beam of photons provided by the optical pump source relative to the single photon source at which single photon emission intensity is maximised.

The particle typically is a sole particle that emits in use photons at a wavelength of the emitted single photons. The particle typically comprises a material having a diamond structure and typically comprises a diamond material such as single or polycrystalline diamond material. The diamond material typically comprises a colour centre. The particle typically has a diameter of the order of 40-150 nm.

Throughout this specification, the term “colour centre” is used for any optically active atomic, molecular or vacancy centre from which photons may be emitted including atomic, molecular or vacancy centres which are arranged for a decay of an excited state via emission of a single photons.

The or each colour centre typically comprises an impurity or impurities in the diamond material. For example, the or each impurity may be a nitrogen atom positioned adjacent a vacancy such that a nitrogen-vacancy (N-V) colour centre is formed. The or each impurity may also be a nickel-related colour centre commonly referred to as a “NE8” colour centre. Such an N-V colour typically is arranged to emit single photons having a wavelength in the vicinity of 637 nm upon suitable excitation.

The a particle for generating the single photons typically comprises one colour centre.

The single photon emission system typically comprises a lens which is arranged to focus photons provided by the optical pump source to a small area such as an area having a diameter of 300-500 nm.

The optical pump source typically is provided in the form of a suitable laser.

The holder typically comprises a recess in which the particle for generating the single photons is positioned. For example, the holder may be provided in the form of an optical fibre portion that has an end-face with the recess.

In one specific embodiment of the present invention the holder is provided in the form of an optical fibre portion comprising a core region and a core-surrounding region. In this embodiment the optical fibre portion comprises a suitable optically transmissive material, such as silica, and a dopant material. In this example the core region comprises a higher dopant concentration and the core-surrounding region and the recess is formed by exposing an end-face of the optical fibre portion to a suitable etching solution which preferentially etches a region having a higher dopant concentration.

The holder may also be provided in the form of an optical fibre portion that comprises a core region that is surrounded by a region which has an optical bandgap at an energy that corresponds to an energy of the emitted single photons. In this case the particle for generating the single photons typically is positioned within the core region, which may be hollow region, and, because of the optical bandgap, emission of single photons in a direction along the core region is facilitated. Consequently, loss of single photon intensity resulting form single photons emitted towards a side portion of the optical fibre is reduced.

The single photon emission system may be arranged so that single photons emitted through the holder are used for further applications. For example, if the holder is an optical fibre portion, the emitted single photons may initially be guided in the optical fibre portion. However, the single photon emission system typically is arranged so that single photons emitted in a direction away from the holder are used for further applications.

The present invention provides in a third aspect a single photon emission system, comprising:
a single photon source arranged for single photon emission at a predetermined wavelength in response to a suitable excitation, the single photon source comprising a particle for generating the single photons, the particle being held by a holder;
an optical pump source arranged to provide the suitable excitation in the form of suitable photons;
a positioner for adjusting a pathway of the photons provided by the optical pump source and a position of the single photon source relative to each other so that in use single photons are emitted by the single photon source; and
a housing in which the single photon source, the optical pump source and the positioner are positioned;
wherein the single photon emission system is arranged so that the single photon emission system is portable.

The single photon emission system according to the third aspect of the present invention typically is arranged for positioning on a suitable table.

The invention will be more fully understood from the following description of specific embodiments of the invention. The description is provided with reference to the accompanying drawings.

### BRIEF DESCRIPTION OF THE DRAWINGS

FIG. 1 shows a flow chart illustrating a method of forming a single photon emission system in accordance with a specific embodiment of the present invention;

FIG. 2 shows an optical element including a single photon source in accordance with an embodiment of the present invention; and

FIG. 3 shows a photon emission system in accordance with a specific embodiment of the present invention.

### DETAILED DESCRIPTION OF SPECIFIC EMBODIMENTS

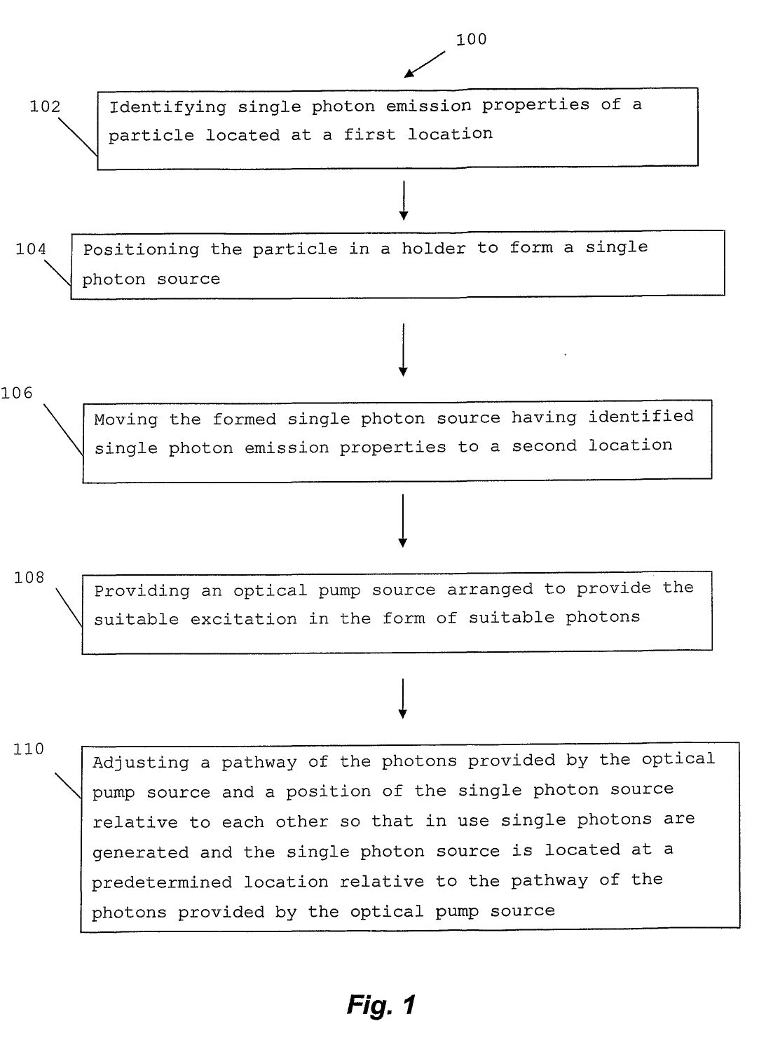

Referring to FIGS. 1 to 3, a method of forming a single photon emission system and a single photon emission system according to specific embodiments of the present invention are now described.

FIG. 1 illustrates the method of forming a single photon emission system in accordance with a specific embodiment.

The method 100 comprises step 102 of identifying single photon emission properties of a particle located at a first location. The particle is arranged for single photon emission at a predetermined wavelength in response to a suitable excitation.

In this embodiment the particle is a diamond particle and identifying single photon emission also comprises depositing a plurality of the diamond particles on a substrate. The diamond particles may be provided in the form of a diamond powder. The particles of the diamond powder are suspended in a suitable solution, such as methanol, and applied to a substrate. The methanol is then evaporated resulting in the deposition of the diamond particles on the substrate, which may be provided in the form of a wafer.

In this embodiment the diamond particles contain impurities, such as nitrogen atoms positioned adjacent a vacancy (N-V colour centre). The N-V colour centre typically is arranged for emission of radiation having a wavelength in the vicinity of 637 nm. The particle arranged for single photon emission typically comprises one NV colour centre. However, the majority of the diamond particles typically comprise more than one NV colour centre.

Further, identifying single photon emission comprises in this example detecting fluorescence radiation from the deposited particles and analysing the fluorescence radiation for single photon emission using an anti-correlation measurement and a Brown-Twiss Interferometer setup. For further details concerning anti-correlation measurements using the Hanbury Brown-Twiss interferometer setup reference is being made to R. Hanbury Brown and R. Q. Twiss, “Correlation between photons in two coherent beams of light.” Nature 177, 27-29 (1956).

The particle for generating the single photons typically is a very small particle and typically has a diameter of the order of 40-150 nm. Consequently, detecting the fluorescent radiation from that particle will not image the particle itself as the resolution of optical imaging methods is insufficient, but will identify a location from which the which the fluorescent radiation originates.

The substrate on which the diamond particles are positioned comprises in this embodiment markers. The step 102 also comprises in this embodiment recording a location of the single photon emission particle relative to a marker.

The method 100 further comprises step 104 of positioning the particle having identified properties in a holder to form a single photon source. This step comprises also imaging the substrate on which the particle for generating the single photons is positioned. The substrate with the marker and the particles is imaged using a secondary electron microscope, which has sufficient resolution for imaging the particles. As the location of the particle for generating the single photons has previously been recorded relative to the markings it is possible to identify that particle in a secondary electron microscopy image.

Further, the method 100 also comprises step 106 of moving the particle from the first location to a second location, which typically is a location on a holder for holding the particle.

In this embodiment the holder comprises an optical fibre. The optical fibre has an end-portion comprising a recess to which the particle for generating the single photons is moved and in which that particle is held in position. In this embodiment, the optical fibre portion is formed from silica that is doped with germanium and comprises a core region that has a higher dopant concentration than a core-surrounding region. The recess is formed in the core region by exposing the end-face of the optical fibre to an etching solution that preferentially etches regions having higher dopant concentrations.

Further details concerning the fabrication of the single photon source are disclosed in the applicants co-pending application entitled “a method of forming a single photon source” filed on the same day as the present application.

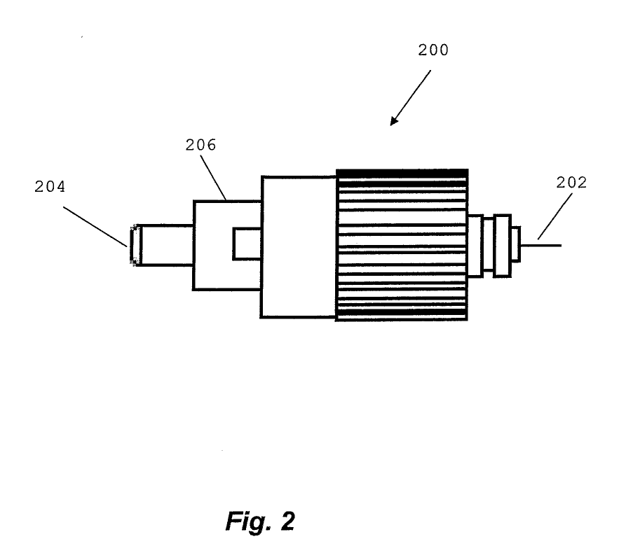

FIG. 2 shows an optical element 200 comprising the formed single photon source 202. The single photon source 202 has a recess at an end-face 204 in which the particle for generating the single photons is positioned. Further, the photon source 202 comprises an fibre optic connector (FC optical connector) 206 in which a ceramic ferrule is positioned locating the optical fibre portion of the single photon source 202.

The optical fibre portion of the single photon source 202 is bonded to the FC optical connector 206 using a suitable optical adhesive that has a very low fluorescent photon emission intensity.

It is to be appreciated that the formed single photon source 202 and the optical element 200 may be provided in different forms. For example, the optical fibre of the single photon source 202 may have a photonic band gap in a region that surrounds the core region and at an energy that corresponds to that of the emitted single photons. Consequently, because of the presence of that band gap, the emission of single photons in a direction along the core is facilitated and it can largely be avoided that photons are emitted in a direction towards a side portion of the optical fibre, which increases the single photon emission intensity.

The method 100 also comprises step 108 of providing an optical pump source arrange to provide the suitable excitation in the form of suitable photons. In this embodiment the optical pump source is a laser that emits radiation at a wavelength of 532 nm.

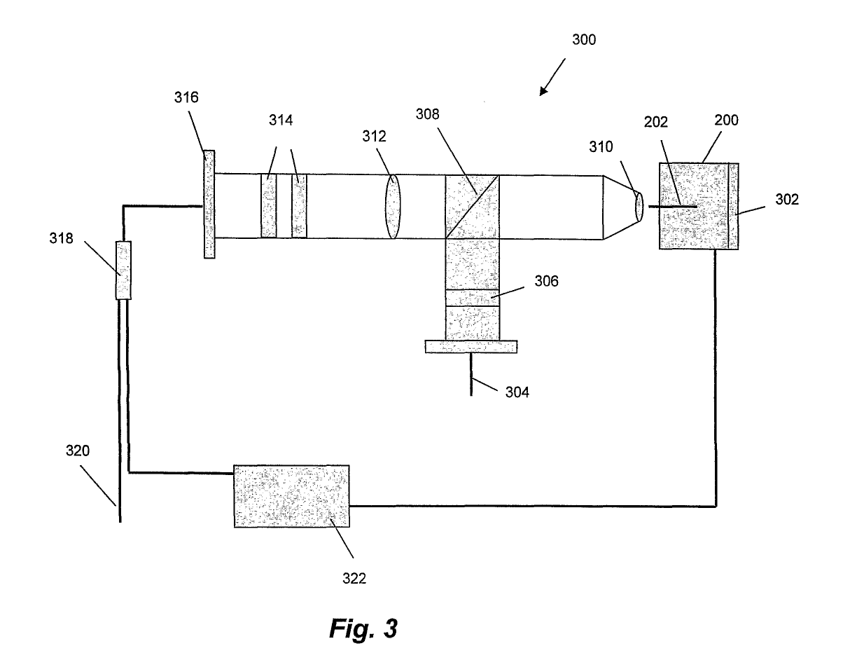

FIG. 3 shows a single photon emission system 300 in accordance with a specific embodiment of the present invention. The single photon emission system 300 comprises the previously described optical element 200 with the single photon source 202. The optical element 200 is positioned on a positioner 302. Further, the single photon emission system 300 comprises an optical pump source that is in this embodiment provided in the form of a laser, which is arranged to generate photons at a wavelength of 532 nm and the generated photons are in use coupled into fibre input 304 (the laser is not shown in FIG. 3). The photons emitted by the laser are then directed via filter 306, beam splitter 308 and microscope objective 310 to the particle for generating the single photons. The filter 306 is a band-pass filter having a window at 532 nm and more than 6 dB attenuation at other wavelengths. The beam splitter 308 comprises a dichroic mirror, which reflects approximately 99% of photon intensity at wavelengths smaller than 600 nm and transmits more than 99% of photons having wavelengths of more than 600 nm. The microscope objective lens 310 is arranged for a magnification of 100 times and has numerical aperture of 0.95.

In this embodiment the single photon emission system 300 is arranged so that single photons that are emitted in a direction away from the optical fibre of the single photon source 202 (towards the left hand side of the single photon source 202 shown in FIG. 2) are used for further applications.

Single photons emitted by the single photon source 202 are directed through the microscope objective 310, the beam splitter 308, a focusing lens 312, filters 314, a optical fibre input 316, a single photon splitter 318 to single photon output 320 or to single photon detector 322. The filters 314 are arranged for a transmission of more than 901 of photons having a wavelength with a range of 600-800 nm and have an attenuation of more than 12 dB at other wavelengths. The single photon detector 322 is connected to the positioner 302 so that a feedback loop is formed.

The method 100 also comprises step 110 of adjusting a pathway of the photons provide by the optical pump source and a position of the single photon source relative to each other so that the single photon source is located at a predetermined location relative to the pathway of the photons provided by the optical pump source and in use single photons are generated.

In this embodiment the step 110 also comprises controlling the positioner 302, and thereby controlling a position of the single photon source 200, via a feedback loop so that single photon emission intensity is maximised. The single photon detector 322 provides in use s signal that is dependant on a detected single photon intensity. The positioner 302 moves the optical element 200 with the single photons source 202 so that the focussed photons from the optical pump laser are scanned across a surface of the single photon source 202.

In this embodiment the microscope objective lens 310 is arranged to focus the photons emitted by the pump laser to a very small spot size, which typically has a diameter of the order of 300-500 nm on the surface of the single photon source 202. Movements of the positioner 302 are computer controlled using a suitable computer software routine. Once the positioner 302 has moved the single photon source 200 to a position at which the focused photons from the optical pump source are directed onto the particle arranged for single photon emission, the photon detector 322 will sense and increase in single photon emission intensity. The suitable computer software routine is then used to control the positioner 302 in a manner such that further small movements of the positioner are conducted and the single photon emission intensity is maximised. Consequently, the single photon emission system 300 comprises in this embodiment a feedback loop for positioning the single photon source 202 to an optimum position.

Further, the single photon emission system 300 typically comprises a housing (not shown) in which all optical and electronic components are positioned. The single photon emission system 300 is in this embodiment a portable device that may be positioned on a table.

Although the invention has been described with reference to particular examples, it will be appreciated by those skilled in the art that the invention may be embodied in many other forms. For example, the particle for generating the single photons may not necessarily be positioned in a recess of an optical fibre, but may alternatively be held in position in any other suitable manner. Further, the particles may be composed of a material other than diamond. In addition, it is to be appreciated that the single photon emission system, which is described with reference to FIG. 3, is only one variation of a number of possible variations that are within the scope of the present invention.

1. A method of forming a single photon emission system, the method comprising:
providing a single photon source arranged for single photon emission at a predetermined wavelength in response to a suitable excitation, the single photon source comprising a particle for generating the single photons, the particle being held by a holder;
providing an optical pump source arranged to provide the suitable excitation in the form of suitable photons;
adjusting a pathway of the photons provided by the optical pump source and a position of the single photon source relative to each other so that the single photon source is located at a predetermined location relative to the pathway of the photons provided by the optical pump source and in use single photons are emitted by the single photon source;
wherein providing the single photon source comprises identifying the particle for generating the single photons at a location that is remote from the predetermined location.

2. The method of claim 1 wherein the step of providing the single photon source comprises identifying a single photon emission property of the particle prior to holding the particle by the holder.

3. The method of claim 1 comprising arranging the single photon source and the optical pump source so that single photons are in use emitted in a direction away from the holder.

4. The method of claim 3 comprising arranging the single photon source and the optical pump source so that single photons are in use emitted in a direction away from the holder without being transmitted through a portion of the holder.

5. A single photon emission system formed by the method in accordance with claim 1.

6. The single photon emission system of claim 5 comprising a positioner for positioning the single photon source and the optical pump source, or an optical component that determines an optical pathway of the photons emitted by the optical pump source, relative to each other so that in use the photons emitted by the optical pump source are directed to the single photon source and single photons are generated.

7. The single photon emission system of claim 6 comprising a feedback loop arranged to control the positioner based on an output of the generated single photons.

8. The single photon emission system of claim 7 wherein the positioner and the feedback loop are arranged so that adjustment of a position of the single photon source relative to the optical pump source, or an optical component that determines an optical pathway of the photons emitted by the optical pump source, can be performed in an automated manner.

9. The single photon emission system of claim 5 wherein the single photon emission system is arranged so that a beam of the photons that are in use emitted by the optical pump source is scanned over a surface of the single photon source.

10. The single photon emission system of claim 5 comprising a single photon detector for providing information concerning a single photon emission output.

11. The single photon emission system of claim 7, wherein the positioner and feedback loop are arranged to identify a position of beam of the photons provided by the optical pump source relative to the single photon source at which a single photon emission intensity is maximised.

12. The single photon emission system of claim 7, wherein control of the positioner is computer software supported.

13. The single photon emission system of claim 5 wherein the particle is a sole particle that emits in use photons at a wavelength of the emitted single photons.

14. The single photon emission system of claim 5 wherein the particle comprises a diamond material that has a colour centre.

15. The single photon emission system of claim 5 wherein the particle has a diameter of the order of 40-150 nm.

16. The single photon emission system of claim 5 wherein the colour centre a nitrogen-vacancy (N-V) colour centre.

17. The single photon emission system of claim 5 wherein the particle for generating the single photons comprises one colour centre.

18. The single photon emission system of claim 5 comprising a lens which is arranged to focus photons provided by the optical pump source to an area having a diameter of 300-500 nm.

19. The single photon emission system of claim 5 wherein the holder comprises a recess in which the particle for generating the single photons is positioned.

20. The single photon emission system of claim 5 wherein the holder is provided in the form of an optical fibre portion that has an end-face with a recess.

21. The single photon emission system of claim 5 wherein the holder is provided in the form of an optical fibre portion that comprises a core region surrounded by a region which has an optical bandgap at an energy that corresponds to an energy of the emitted single photons and wherein the particle for generating the single photons is positioned within the core region.

22. The single photon emission system of claim 5 wherein the single photon emission system is arranged so that single photons emitted in a direction away from the holder are used for further applications.

23. A single photon emission system, comprising:
a single photon source arranged for single photon emission at a predetermined wavelength in response to a suitable excitation, the single photon source comprising a particle for generating the single photons, the particle being held by a holder;
an optical pump source arranged to provide the suitable excitation in the form of suitable photons;
a positioner for adjusting a pathway of the photons provided by the optical pump source and a position of the single photon source relative to each other so that in use single photons are emitted by the single photon source; and
a housing in which the single photon source, the optical pump source and the positioner are positioned;
wherein the single photon emission system is arranged so that the single photon emission system is portable.

24. The single photon emission system of claim 23 wherein the single photon emission system is arranged for positioning on a suitable table.
